(19) United States
(12) Patent Application Publication
(10) Pub. No.: US 2024/0077917 A1
(43) Pub. Date: Mar. 7, 2024

(54) DUAL PHONE CASE HAVING WIRELESS CHARGING FUNCTION

(71) Applicant: CNPS.COM LIMITED, DONGYING (CN)

(72) Inventor: BING WEI, DONGYING (CN)

(21) Appl. No.: 18/058,777

(22) Filed: Nov. 25, 2022

(30) Foreign Application Priority Data
Sep. 2, 2022 (CN) 202222346372.2
Sep. 2, 2022 (CN) 202222347189.4

(51) Int. Cl. G06F 1/16; H02J 50/00; H02J 50/10; H02J 50/40

(52) U.S. Cl. CPC G06F 1/1683; H02J 50/005; H02J 50/10; H02J 50/402; H02J 2310/22

(57) ABSTRACT

A dual phone case having wireless charging function, including a flexible board, a first case, a second case, and a wireless charging assembly. The flexible board includes a first mounting portion and a second mounting portion, where the first mounting portion is folded with the second mounting portion. The first case is disposed on the first mounting portion, the second case is disposed on the second mounting portion, and the first case and the second case are configured to fix mobile phones. The wireless charging assembly is configured to wirelessly charge the mobile phone, and the wireless charging assembly is disposed on the flexible board. The dual phone case charges the two mobile phones at the same time while protecting the two mobile phones at the same time.

### TECHNICAL FIELD

The present disclosure relates to a technical field of phone cases, and in particular to a dual phone case having wireless charging function.

### BACKGROUND

Currently, with the innovating of technologies related to mobile phone charging, more mobile phones are started to provide with a more flexible wireless charging technology, and phone cases, serving as a basic accessory for protecting an outer shape of the mobile phones are also innovated, which provide wireless charging for the mobile phones while protecting the mobile phones from being collided.

However, one phone case having wireless charging function can only protect and charge one mobile phone, and when a user holds two mobile phones, the one phone case is unable to protect and charge the two mobile phones at the same time, which is very inconvenient in use.

### SUMMARY

The present disclosure provides a dual phone case having wireless charging function for solving a problem that one phone case having wireless charging function is unable to protect and charge two mobile phones at the same time proposed in the background.

In order to solve the problem, the present disclosure provides a dual phone case having wireless charging function, including a flexible board, a first case, a second case, and a wireless charging assembly. The flexible board is foldable and includes a first mounting portion and a second mounting portion, where the first mounting portion and the second mounting portion are connected in sequence. The first case is disposed on the first mounting portion, the second case is disposed on the second mounting portion, the first case and the second case are configured to fix mobile phones. The wireless charging assembly is disposed on the flexible board and is configured to wirelessly charge the mobile phones.

Furthermore, the flexible board further includes a folding portion, the folding portion is disposed between the first mounting portion and the second mounting portion. The first mounting portion and the second mounting portion are folded along the folding portion, the first case is rotated and folded along with the first mounting portion along the folding portion and abuts against the second case.

Furthermore, the flexible board further includes a first folding portion, a connecting portion, and a second folding portion. The first mounting portion, the first folding portion, the connecting portion, the second folding portion, and the second mounting portion are connected in sequence. The first case is capable of rotating along with the first mounting portion and the first folding portion to abut against a first side of the connecting portion, and the second case is capable of rotating along with the second mounting portion and the second folding portion to abut against a second side of the connecting portion.

Furthermore, the first case is detachably disposed on the first mounting portion through a first connecting assembly. And/or the second case is detachably disposed on the second mounting portion through a second connecting assembly.

Furthermore, the first connecting assembly includes a first magnetic component and a second magnetic component, the first magnetic component is fixedly disposed on the first mounting portion, and the second magnetic component is fixedly disposed on the first case, one of the first magnetic component and the second magnetic component is a first magnet, another one of the first magnetic component and the second magnetic component is a second magnet or a first magnetic metal. And/or the second connecting assembly includes a third magnetic component and a fourth magnetic component, the third magnetic component is fixedly disposed on the second mounting portion, and the fourth magnetic component is fixedly disposed on the second case, one of the third magnetic component and the fourth magnetic component is a third magnet, another one of the third magnetic component and the fourth magnetic component is a fourth magnet or a second magnetic metal.

Furthermore, the wireless charging assembly includes a first charging coil, a second charging coil, and a charging circuit board, where at least one charging interface is disposed on the charging circuit board. The first charging coil and the second charging coil are respectively disposed on the first mounting portion and the second mounting portion. The charging circuit board is respectively and electrically connected to the first charging coil and the second charging coil.

Furthermore, the charging circuit board is a flexible circuit board, the flexible circuit board is disposed on a lower portion of the flexible board and further crosses the first mounting portion, the folding portion, and the second mounting portion. The at least one charging interface is disposed on a lower portion of the folding portion and is further connected to the flexible circuit board.

Furthermore, the charging circuit board is a hard circuit board, the hard circuit board is disposed in the folding portion and is electrically connected to the first charging coil and the second charging coil through leading wires. The at least one charging interface is disposed on a lower portion of the hard circuit board and is further electrically connected to the hard circuit board.

Furthermore, a first indicating lamp and a second indicating lamp are disposed on the at least one charging interface. The first indicating lamp and the second indicating lamp are respectively and electrically connected to the first charging coil and the second charging coil through the charging circuit board.

Furthermore, the dual phone case having wireless charging function further includes a battery module. The battery module is disposed on the folding portion, and the battery module is electrically connected to the charging circuit board.

Furthermore, the wireless charging assembly includes a first charging coil, a second charging coil, and a charging circuit board, where at least one charging interface is disposed on the charging circuit board. The first charging coil and the second charging coil are respectively disposed on the first mounting portion and the second mounting portion, and the charging circuit board is respectively and electrically connected to the first charging coil and the second charging coil.

Furthermore, the charging circuit board is a flexible circuit board, the flexible circuit board is disposed on a lower portion of the flexible board and further crosses the first mounting portion, the first folding portion, the connecting portion, the second folding portion, and the second mounting portion. The at least one charging interface is disposed on a lower portion of the folding portion and is further connected to the flexible circuit board.

Furthermore, the charging circuit board is a hard circuit board, the hard circuit board is disposed in the folding portion and is electrically connected to the first charging coil and the second charging coil through leading wires. The at least one charging interface is disposed on a lower portion of the hard circuit board and is further electrically connected to the hard circuit board.

Furthermore, the dual phone case having wireless charging function further includes a battery module. The battery module is disposed on the connecting portion, and the battery module is electrically connected to the charging circuit board.

Furthermore, a connecting strip is disposed on an edge of the first mounting portion. A fifth magnetic component is disposed on the connecting strip, a sixth magnetic component is disposed on the second mounting portion. The connecting strip is detachably connected to the second mounting portion through the fifth magnetic component and the sixth magnetic component when the flexible board is in a folded state. One of the fifth magnetic component and the sixth magnetic component is a fifth magnet, and another one of the fifth magnetic component and the sixth magnetic component is a sixth magnet or a third magnetic metal.

Furthermore, a first connecting strip is disposed on the first mounting portion, and a fifth magnetic component is disposed on the first connecting strip. A second connecting strip is disposed on the second mounting portion, and a sixth magnetic component is disposed on the second connecting strip. The first connecting strip and the second connecting strip are connected through the fifth magnetic component and the sixth magnetic component when the flexible board is in a folded state. One of the fifth magnetic component and the sixth magnetic component is a fifth magnet, and another one of the fifth magnetic component and the sixth magnetic component is a sixth magnet or a third magnetic metal.

Furthermore, a first connecting strip is disposed on the first mounting portion, a fifth magnetic component is disposed on the first connecting strip, and a sixth magnetic component is disposed on the second folding portion. One of the fifth magnetic component and the sixth magnetic component is a fifth magnet, and another one of the fifth magnetic component and the sixth magnetic component is a sixth magnet or a third magnetic metal. The first connecting strip is detachably connected to the second folding portion through the fifth magnetic component and the sixth magnetic component when the flexible board is in a folded state. And/or a second connecting strip is disposed on the second mounting portion, a seventh magnetic component is disposed on the second connecting strip, and an eighth magnetic component is disposed on the first folding portion. One of the seventh magnetic component and the eighth magnetic component is a seventh magnet, and another one of the seventh magnetic component and the eighth magnetic component is an eighth magnet or a fourth magnetic metal. The second connecting strip is detachably connected to the first folding portion through the seventh magnetic component and the eighth magnetic component when the flexible board is in the folded state.

Furthermore, the flexible board is formed through connecting a plurality of leather pieces, mounting inner cavities are respectively defined on inner sides of the plurality of the leather pieces, and the mounting inner cavities are communicated and are configured to mount the wireless charging assembly.

Beneficial effects of the present disclosure are that, compared with the prior art, the present disclosure provides the wireless charging assembly on the flexible board, where the flexible board is foldable and capable of mounting two mobile phones, to achieve that the dual phone case charges the two mobile phones at the same time while protecting the two mobile phones at the same time, which is convenient for users to store and carry the two mobile phones without affecting work and use efficiency, thereby improving a degree of satisfaction of the users.

### BRIEF DESCRIPTION OF DRAWINGS

The present disclosure will be further described below with reference to the accompanying drawings and embodiments, in which:

FIG. 1 is a schematic diagram of an unfolded state of a dual phone case having wireless charging function according to a first embodiment of the present disclosure.

FIG. 2 is a schematic diagram of a folded state of the dual phone case having wireless charging function according to the first embodiment of the present disclosure.

FIG. 3 is a schematic diagram illustrating a connection between a flexible board and a second case according to the first embodiment of the present disclosure.

FIG. 4 is a structural schematic diagram of a first connecting assembly and a second connecting assembly according to the first embodiment of the present disclosure.

FIG. 5 is a schematic diagram of a mounting position where a wireless charging assembly is disposed on the flexible board according to the first embodiment of the present disclosure.

FIG. 6 is a schematic diagram of another embodiment of a charging interface according to the first embodiment of the present disclosure.

FIG. 7 is a structural schematic diagram of the charging interface according to the first embodiment of the present disclosure.

FIG. 8 is a schematic diagram of another embodiment of the flexible board according to the first embodiment of the present disclosure.

FIG. 9 is a schematic diagram of another embodiment of the wireless charging assembly according to the first embodiment of the present disclosure.

FIG. 10 is a schematic diagram of an unfolded state of a dual phone case having wireless charging function according to a second embodiment of the present disclosure.

FIG. 11 is a schematic diagram of a folded state of the dual phone case having wireless charging function according to the second embodiment of the present disclosure.

FIG. 12 is a structural schematic diagram of a first connecting assembly according to the second embodiment of the present disclosure.

FIG. 13 is a structural schematic diagram of a second connecting assembly according to the second embodiment of the present disclosure.

FIG. 14 is a structural schematic diagram of a first mounting portion on a flexible board according to the second embodiment of the present disclosure.

FIG. 15 is a structural schematic diagram of a second mounting portion on the flexible board according to the second embodiment of the present disclosure.

FIG. 16 is a schematic diagram of another embodiment of charging interfaces according to the second embodiment of the present disclosure.

FIG. 17 is a schematic diagram of a first indicating lamp and a second indicating lamp on the charging interface according to the second embodiment of the present disclosure.

FIG. 18 is a schematic diagram of another embodiment of a wireless charging assembly according to the second embodiment of the present disclosure.

Reference numerals in the drawings: 1. flexible board; 1. first mounting portion; 111. third camera hole; 110. connecting strip; 12. folding portion; 120. first folding portion; 121. connecting portion; 122. second folding portion; 13. second mounting portion; 30. second connecting strip; 131. fourth camera hole; 14. connecting strip; 2. first case; 21. first camera hole; 3. second case; 31. second camera hole; 4. wireless charging assembly; 41. charging interface; 411. first indicating lamp; 412. second indicating lamp; 42. battery module; 43. flexible circuit board; 44. first charging coil; 45. second charging coil; 5. first connecting assembly; 51. first magnetic component; 52. second magnetic component; 6. second connecting assembly; 61. third magnetic component; and 62. fourth magnetic component.

### DETAILED DESCRIPTION

Unless otherwise defined, all technical and scientific terms used herein have the same meaning as commonly understood by those skilled in the art. The terms used herein in the specification are for the purpose of describing specific embodiments only and are not intended to limit the present disclosure. For example, the terms “length”, “width”, “upper”, “lower”, “left”, “right”, “front”, “rear”, “vertical”, “horizontal”, “top”, “bottom”, “inner”, “outer” and the like are used to describe the orientation or position shown in the drawings, and are merely convenient to describe and cannot be understood as limitations to the technical solution.

The terms “include” and “have” and any variations thereof in the specification and claims of the present disclosure and the above drawings are intended to cover non-exclusive inclusion. The terms “first”, “second” and the like in the specification and claims of the present disclosure or the accompanying drawings are used to distinguish different objects, and are not used to describe a specific order. The meaning of “a plurality of” is two or more, unless specifically defined otherwise.

In the specification and claims of the present disclosure and the above description, when an element is referred to as being “fixed to” or “mounted on” or “disposed on” or “connected to” another element, the element may be directly or indirectly located on the other element. For example, when an element is referred to as being “connected to” another element, the element may be directly or indirectly connected to the other element.

In addition, reference to “one embodiment” herein means that a particular feature, structure, or characteristic described in connection with one embodiment may be included in at least one embodiment of the present disclosure. The appearances of the phrases in various positions in the specification are not necessarily all referring to the same embodiment, and are not independent or alternative embodiments mutually exclusive of other embodiments. Those skilled in the art explicitly and implicitly understand that the embodiments described herein may be combined with other embodiments.

Phone cases play a role in protecting mobile phones from being collided in daily life. With the development that wireless charging technology is widely applied in the mobile phones, the phone cases are further improved to provide a wireless charging function while protecting the mobile phones. However, conventional phone cases having wireless charging function merely support that one phone case charges one mobile phone, when users have more than one mobile phones, more than one phone cases having wireless charging function and more than one external power supplies are required, which is inconvenient for storing and carrying.

### First Embodiment

The first embodiment of the present disclosure provides a dual phone case having wireless charging function, which connects two cases to a flexible board embedded with a wireless charging assembly for wirelessly charging two mobile phones at the same time. What's more, the two mobile phones and the two cases may rotate along folding of a folding portion along with a first mounting portion and a second mounting portion for being convenient for users to use and store.

In order to make those skilled in the art better understand the solutions of the embodiments of the present disclosure, the technical solutions in the embodiments of the present disclosure will be clearly and completely described below with reference to the accompanying drawings.

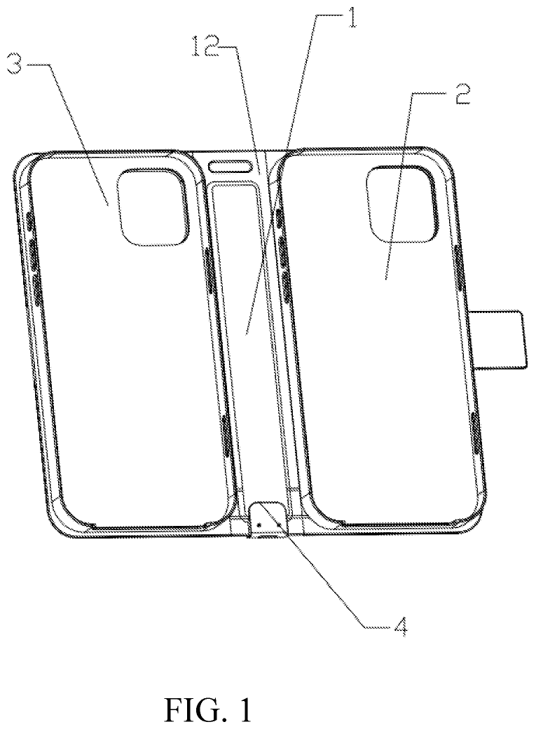

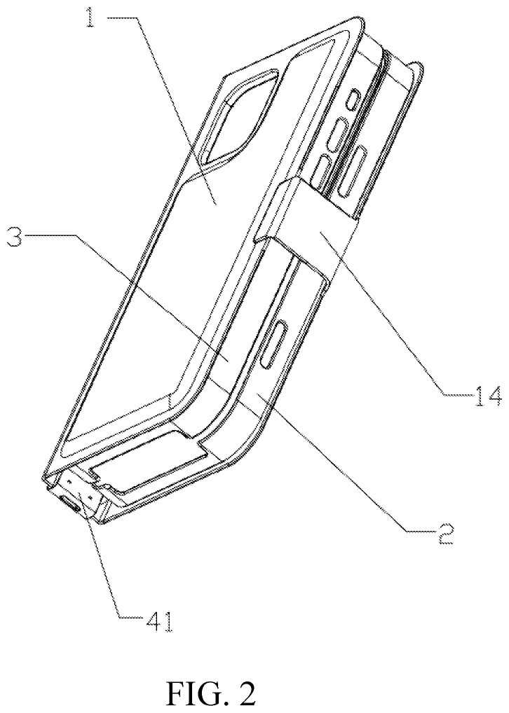

As shown in FIGS. 1-9, the present disclosure provides a dual phone case having wireless charging function, including a flexible board 1, a first case 2, a second case 3, and a wireless charging assembly 4. The flexible board 1 includes a first mounting portion 11, a folding portion 12, and a second mounting portion 13, where the first mounting portion 11, the folding portion 12, and the second mounting portion 13 are connected in sequence. The first mounting portion 11 and the second mounting portion 13 are folded along the folding portion 12. The first case 2 is disposed on the first mounting portion 11 for fixing a mobile phone, the second case 3 is disposed on the second mounting portion 13 for fixing the mobile phone. The wireless charging assembly 4 is disposed on the flexible board 1 and is configured to wirelessly charge the mobile phone.

Specifically, the first mounting portion 11, the folding portion 12, and the second mounting portion 13 are arranged in a length direction of the flexible board 1, the flexible board 1 may be folded through the folding portion 12, when the flexible board 1 is in a folded state, the first mounting portion 11 is stacked on the second mounting portion 13 and faces opposite to the second mounting portion 13, the folding portion 12 is perpendicular to the first mounting portion 11 and the second mounting portion 13, and a width of the folding portion 12 matches a sum of thicknesses of the first case 2 and the second case 3. When the flexible board 1 is in an unfolded state, the first case 2 and the second case 3 are respectively and detachably disposed on the first mounting portion 11 and the second mounting portion 13, which is convenient for stacking and storing the mobile phone and is further convenient for carrying the mobile phone. When the wireless charging assembly 4 is powered on, the mobile phone mounted on the first case 2 or the second case 3 may be charged through the wireless charging assembly 4 disposed on the flexible board 1, so that the mobile phone is convenient to carry and meanwhile a function of wirelessly charging two mobile phones at the same time is further satisfied, and practicability is further improved. In the embodiment, the mobile phones are provided with a wireless charging function.

In addition, when the two mobile phones are conveniently carried, the two mobile phones may be further associated, so that intelligent mobile phone tasks, such as making a call, receiving a call, shooting photos, and web browsing, may be carried out at the same time; or an independent task may be respectively carried out on the two mobile phones, therefor improving user experience. Certainly, the users may also only carry or use any one of the two mobile phones.

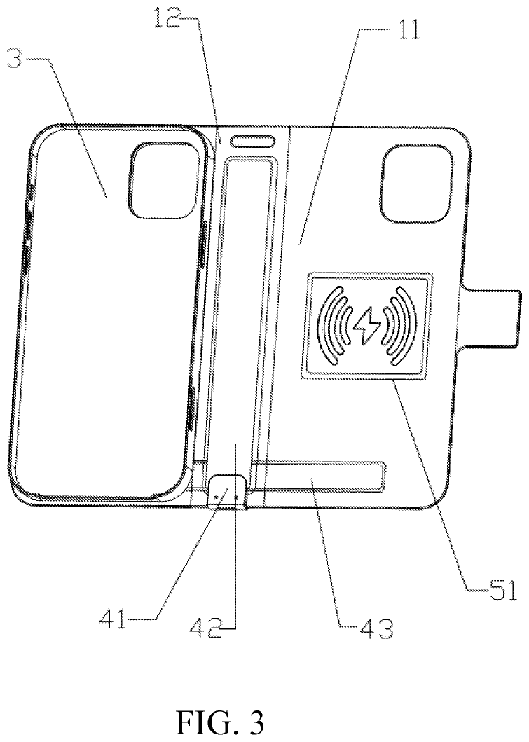

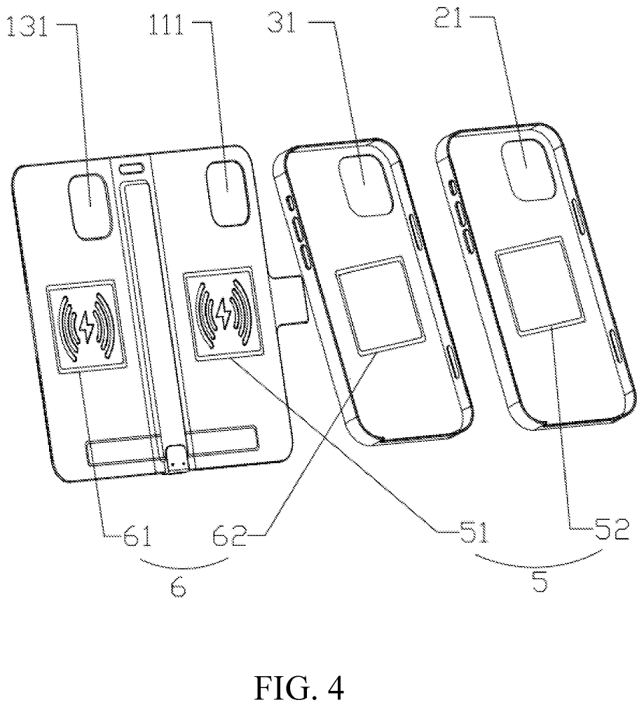

In one embodiment, as shown in FIGS. 3-4, the first case 2 is detachably disposed on the first mounting portion 11 through a first connecting assembly 5; and/or the second case 3 is detachably disposed on the second mounting portion 13 through a second connecting assembly 6. Such form of detachable connection is convenient for the users to disassemble and assemble and use the dual phone case having wireless charging function according to actual requirements for use. For example, when there is no charging requirement and there is only one mobile phone to be used, the first case 2 and the first mounting portion 11 may be separated, so as to hold and further manipulate the one mobile phone; and when there is a charging requirement, the first case 2 and the mobile phone are together mounted on the first mounting portion 11, which is flexible and convenient and further improves the user experience.

Further, the first connecting assembly 5 and the second connecting assembly 6 may be configured to be in various assembly forms. For example, the first connecting assembly 5 may be configured to be in a form of a clamping assembly, that is, a clamping component and a clamping buckle are respectively disposed on the first mounting portion 11 and the first case 2, and the first case 2 is quickly disassembled and assembled through a cooperative relationship between the clamping component and the clamping buckle; or the first connecting assembly 5 may be a hook-and-loop fastener assembly, that is, a hook surface of the hook-and-loop fastener and a loop surface of the hook-and-loop fastener are respectively disposed on the first mounting portion 11 and the first case 2, thereby quickly disassembling and assembling the first case 2. When there is a charging requirement, the mobile phone is mounted on the first case 2 and is connected to the first mounting portion 11 through the first connecting assembly 5, and then the mobile phone is capable of being charged, when there is only one mobile phone required, only the first connecting assembly 5 is required to disassemble to quickly separate the first case 2 and the first mounting portion 11. Similarly, the second connecting assembly 6 disposed between the second case 3 and the second mounting portion 13 may be also configured to be in various assembly forms, and the second case 3 and the second mounting portion 13 are quickly separated through disassembling the second connecting assembly 6.

In one embodiment, as shown in FIG. 4, the first connecting assembly 5 includes a first magnetic component 51 and a second magnetic component 52, the first magnetic component 51 is fixedly disposed on the first mounting portion 11, and the second magnetic component 52 is fixedly disposed on the first case 2, one of the first magnetic component 51 and the second magnetic component 52 is a first magnet, another one of the first magnetic component 51 and the second magnetic component 52 is a second magnet or a first magnetic metal. The second connecting assembly 6 includes a third magnetic component 61 and a fourth magnetic component 62, the third magnetic component 61 is fixedly disposed on the second mounting portion 13, and the fourth magnetic component 62 is fixedly disposed on the second case 3, one of the third magnetic component 61 and the fourth magnetic component 62 is a third magnet, another one of the third magnetic component 61 and the fourth magnetic component 62 is a fourth magnet or a second magnetic metal.

The first connecting assembly 5 and the second connecting assembly 6 are configured to be in a form of magnetic structure, which is not only convenient for disassembling and assembling, but also simple in structure and convenient for manufacturing and using, and further has other advantages. Specifically, the first magnetic component 51 and the second magnetic component 51 of the first connecting assembly 5 may be interchangeably disposed between the first case 2 and the first mounting portion 11, that is, a magnet may be disposed on the first case 2 and a magnetic metal is disposed in the first mounting portion 11, and a magnetic function may also be achieved on the contrary. Similarly, the third magnetic component 61 and the fourth magnetic component 62 of the second connecting assembly 6 disposed between the second case 3 and the second mounting portion 13 are interchangeably disposed between the second case 3 and the second mounting portion 13.

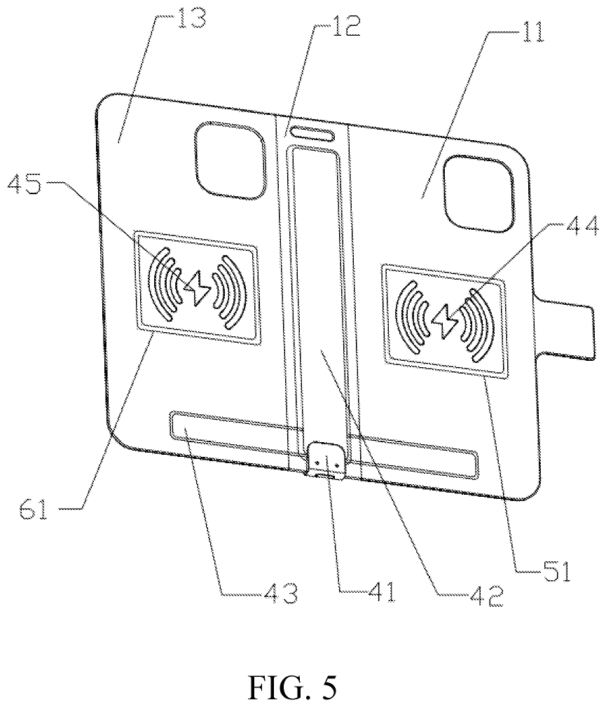

In one embodiment, as shown in FIG. 5, the wireless charging assembly 4 includes a first charging coil 44, a second charging coil 45, and a charging circuit board, where at least one charging interface 41 is disposed on the charging circuit board. The first charging coil 44 and the second charging coil 45 are respectively disposed on the first mounting portion 11 and the second mounting portion 13. The charging circuit board is respectively and electrically connected to the first charging coil 44 and the second charging coil 45.

Specifically, the wireless charging assembly 4 is embedded in the flexible board 1, the first charging coil 44 and the second charging coil 45 are respectively embedded in the first mounting portion 11 and the second mounting portion 13, which are generally disposed at central positions of the first mounting portion 11 and the second mounting portion 13 for corresponding to charging positions of the mobile phones to achieve higher charging efficiency. Certainly, the first charging coil 44 and the second charging coil 45 may further disposed at other positions of the first mounting portion 11 and the second mounting portion 13, and corresponding charging efficiency may also be achieved through increasing coverage areas of the first charging coil 44 and the second charging coil 45. In one embodiment, a charging circuit connecting the at least one charging interface 41 with the first charging coil 44 and the second charging coil 45 is disposed on the charging circuit board. Specifically, the charging circuit belongs to a prior art, and details of which are not described herein.

In one embodiment, as shown in FIG. 5, the charging circuit board is a flexible circuit board 43, the flexible circuit board 43 is disposed on a lower portion of the flexible board 1 and further crosses the first mounting portion 11, the folding portion 12, and the second mounting portion 13. The at least one charging interface 41 is disposed on a lower portion of the folding portion 12 and is further connected to the flexible circuit board 43.

Specifically, the flexible circuit board 43 is disposed on one side along the length direction of the flexible board 1, the flexible circuit board 43 is sequentially connected to the first mounting portion 11, the folding portion 12, and the second mounting portion 13, and is electrically connected to the first charging coil 44 and the second charging coil 45. Current entering from the at least one charging interface 41 is distributed in the flexible circuit board 43, when the two mobile phones required to be charging are connected to the first mounting portion 11 and the second mounting portion 13 through the first case 2 and the second case 3, the entered current is distributed to the first charging coil 44 and the second charging coil 45 through the flexible circuit board 43. Correspondingly, when there is only one mobile phone, the flexible circuit board 43 only distributes the current to one end connected with the one mobile phone, the structure of which improves charging efficiency of the phone case having wireless charging function on a basis of satisfying a charging function.

In addition, when there is only one charging interface 41 disposed, the one charging interface 41 is disposed on one end, close to the folding portion 12, of the flexible circuit board 43, the one charging interface 41 connects external current into the flexible circuit board 43.

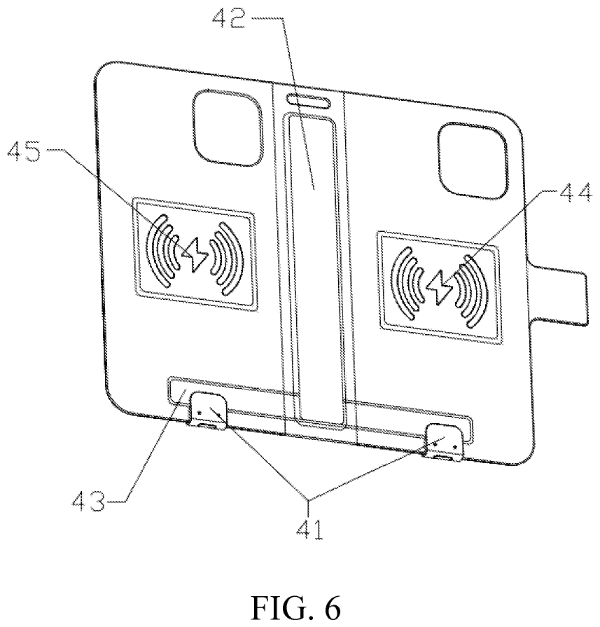

In one embodiment, as shown in FIG. 6, when there are two charging interfaces 41 disposed, the two charging interfaces 41 are respectively disposed on edges, close to the flexible circuit board 43, of the first mounting portion 11 and the second mounting portion 13 on the flexible board 1, and the two charging interfaces 41 are respectively and electrically connected to the flexible circuit board 43. The two charging interfaces 41 may be configured to be of the same type or different types. For example, one of the two charging interfaces 41 is configured to be a Micro USB interface, and another one of the two charging interfaces 41 is a Micro USB interface or a USB type C interface. Such configuration may satisfy various charging situations, expand a range of application of the dual phone case having wireless charging function, and improve practicability.

It should be noted that a number of the charging interface 41 in the present disclosure is configured to be at least one, a type of the charging interface 41 may be configured to be the Micro USB interface, USB type C interface, or other charging interfaces capable of providing charging function. The number and the type of the charging interface 41 are not further limited in the present disclosure.

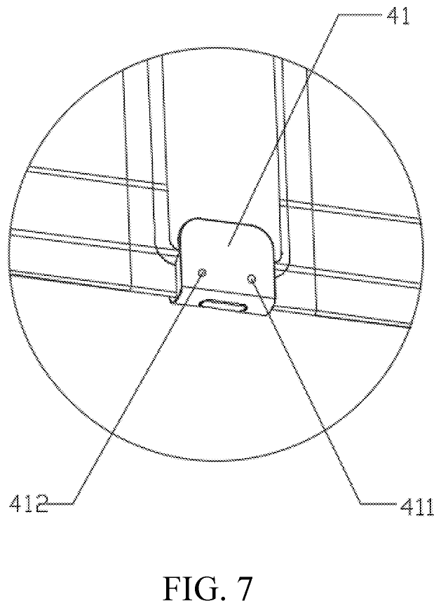

In one embodiment, as shown in FIG. 7, a first indicating lamp 411 and a second indicating lamp 412 are disposed on the at least charging interface, the first indicating lamp 411 and the second indicating lamp 412 are respectively and electrically connected to the first charging coil 44 and the second charging coil 45 through the flexible circuit board 43.

Specifically, when the wireless charging assembly 4 is connected to an external power supply, the first indicating lamp 411 and the second indicating lamp 412 emit green lights. When the first charging coil 44 and the second charging coil 45 begin to work, the first indicating lamp 411 and the second indicating lamp 412 emit red lights, when the mobile phone is fully charged, a charging detection circuit disposed in the flexible circuit board 43 detects that charging current is continuously lower than a certain value, a connection between the wireless charging assembly 4 and the mobile phone may be automatically cut off, and at this time, the first indicating lamp 411 and the second indicating lamp 412 emit green lights again for indicating that the mobile phone is fully charged. Such assembly may remind users of stopping charging through light-emitting colors, thereby avoiding danger caused by overcharge of the mobile phone and further improving security.

It should be noted that the light-emitting colors of the first indicating lamp 411 and the second indicating lamp 412 in the present disclosure are in a principle of being convenient for identification, and the light-emitting colors are not limited in the present disclosure.

It should be also noted that both the charging detection circuit and indicating lamp circuit disposed in the flexible circuit board 43 are prior art, and details of which are not described herein again.

In one embodiment, which not shown in the drawings, the dual phone case having wireless charging function further includes a battery module 42, the battery module 42 is disposed on the folding portion 12, the battery module 42 is electrically connected to the flexible circuit board 43. The battery module 42 is disposed on the folding portion 12 as a backup power source, so that power is provided for the wireless charging assembly 4 without the external power supply, when the external power supply is connected, the battery module 42 is charged while charging the mobile phone, and at the same time, the battery module 42 further plays a role in supporting. When the flexible board 1 is folded, the battery module 42 in the folding portion 12 is supported between the first mounting portion 11 and the second mounting portion 13, which prevents a mobile phone mounted in the first case 2 from contacting with a mobile phone mounted in the second case 3 and further prevents the mobile phones from being damaged. Thereby, functionality of the dual phone case having wireless charging function is improved and the user experience is improved.

In one embodiment, as shown in FIGS. 1-6, a connecting strip 14 is disposed on an edge of the first mounting portion 11. A fifth magnetic component is disposed on the connecting strip 14, a sixth magnetic component is disposed on the second mounting portion 13. The connecting strip 14 is detachably connected to the second mounting portion 13 through the fifth magnetic component and the sixth magnetic component when the flexible board 1 is in a folded state. One of the fifth magnetic component and the sixth magnetic component is a fifth magnet, and another one of the fifth magnetic component and the sixth magnetic component is a sixth magnet or a third magnetic metal.

Specifically, after the flexible board 1 and the first case 2 and the second case 3 are folded along the folding portion 12, the flexible board is easily unfolded during a carrying process, so that the mobile phones mounted in the first case 1 and the second case 3 fall off or are damaged. The connecting strip 14 fixes the folded first mounting portion 11 and the folded second mounting portion 13 through cooperation of the fifth magnetic component and the sixth magnetic component, so that the flexible board 1 is kept in the folded state. Thereby, a situation that the mobile phones are damaged due to a fact that the dual phone case having wireless charging function is easily unfolded during the carrying process is prevented, and the practicability is further improved.

Specifically, a connection form of the connecting strip 14 is similar to the first connecting assembly 5 and the second connecting assembly 6, and magnet effect between the fifth magnetic component and the sixth magnetic component is convenient for detachable connection of the connecting strip 13 and fix the folded state of the flexible board 1, which is simple in structure and convenient in operation. Certainly, the connection form of the connecting strip 14 may be further configured to be in connection forms of a hook-and-loop fastener assembly or clamping assembly, or connection forms satisfied to fix the folded state of the flexible board 1 and be convenient for operation.

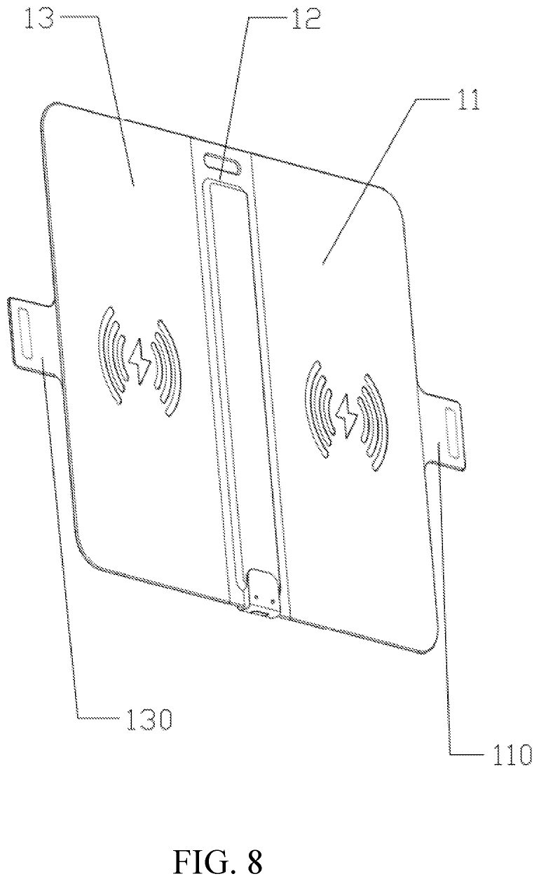

In one embodiment, as shown in FIG. 8, a first connecting strip 110 is disposed on the first mounting portion 11, and a fifth magnetic component is disposed on the first connecting strip 110, which are not shown in the drawings. A second connecting strip 130 is disposed on the second mounting portion 13, and a sixth magnetic component is disposed on the second connecting strip 130, which are not shown in the drawings. The first connecting strip 110 and the second connecting strip 130 are connected through the fifth magnetic component and the sixth magnetic component when the flexible board 1 is in a folded state. One of the fifth magnetic component and the sixth magnetic component is a fifth magnet, and another one of the fifth magnetic component and the sixth magnetic component is a sixth magnet or a third magnetic metal.

The first connecting strip 110 and the second connecting strip 130 are disposed on edges of two symmetrical sides of flexible board 1 along the folding portion 12, and the first connecting strip 110 and the second connecting strip 130 are detachably connected through the fifth magnetic component and the sixth magnetic component, and meanwhile, the folded state of the flexible board 1 is fixed, so that the first case 2 and the second case 3 are kept in a stacked state, and the mobile phones are prevented from sliding down from first case 2 and the second case 3.

Furthermore, as shown in FIG. 4, a first camera hole 21 and a second camera hole 31 are respectively disposed on the first case 2 and the second case 3, and the first camera hole 21 and the second camera hole 31 coincide with a third camera hole 111 defined on the first mounting portion 11 and a fourth camera hole 131 defined on the second mounting portion 13.

Specifically, the first camera hole 21 and the third camera hole 111 correspond to positions of cameras of the mobile phone mounted on the first case 2. For example, in the embodiment, the cameras of the mobile phone are disposed on a vertex angle of the mobile phone, correspondingly, the first camera hole 21 is defined at a vertex angle of the first case 2, and the third camera hole 111 is defined at a vertex angle of the first mounting portion 11, so that normal use, such as shooting photos, of the mobile phone may not be affected in a charging or carrying process. The second case 3 and the second mounting portion 13 have similar configuration principle, and the practicability is higher.

Furthermore, the first mounting portion 11 and the second mounting portion 13 are disposed the same side of the flexible board 1, the first case 2 rotates along with the first mounting portion 11 along the folding portion 12 and abuts against the second case 3. Specifically, the first mounting portion 11 and the second mounting portion 13 are disposed on the flexible board 1 in the same orientation, and the first mounting portion 11 and the second mounting portion 13 are both folded in a direction toward where the first mounting portion 11 and the second mounting portion 13 are oriented, thereby improving the portability of the dual phone case having wireless charging function when the dual phone case is in a folded state.

Furthermore, areas of the first mounting portion 11 and the second mounting portion 13 are respectively greater than areas of the first case 2 and the second case 3. The first case 2 and the second case 3 are respectively and centrally disposed on the first mounting portion 11 and the second mounting portion 13, and partial portions of the first mounting portion 11 and the second mounting portion 13 are left at peripheries of the first case 2 and the second case 3, so that the mobile phones and a wireless charging device mounted in the dual phone case having wireless charging function may be better protected.

Furthermore, a rope hanging hole for connecting a hanging rope is defined on the folding portion 12, the rope hanging hole is defined on an upper portion of the folding portion 12 for facilitating connecting the hanging rope, and the dual phone case having wireless charging function may be hung on a neck or other portable portions through the hanging rope, which is simple in structure and convenient in use.

In one embodiment, the flexible board 1 is formed through connecting the first mounting portion 11, the second mounting portion 13, and the folding portion 12, where the first mounting portion 11, the second mounting portion 13, and the folding portion 12 are made by three leather pieces, mounting inner cavities are respectively defined on inner sides of the three leather pieces, and the mounting inner cavities are communicated and are configured to mount the wireless charging assembly 4. Selecting leather as a material for making the flexible board 1 improves a comfort level of the dual phone case having wireless charging function, and further improves the user experience. Certainly, the flexible board 1 may also be made of plastic or other materials having lower hardness and may capable of manufacturing inner cavities, and the material of the flexible board 1 is not further limited in the present disclosure.

### Second Embodiment

A structure of the dual phone case having wireless charging function in the second embodiment is approximately the same as that of the first embodiment, and differences are as following.

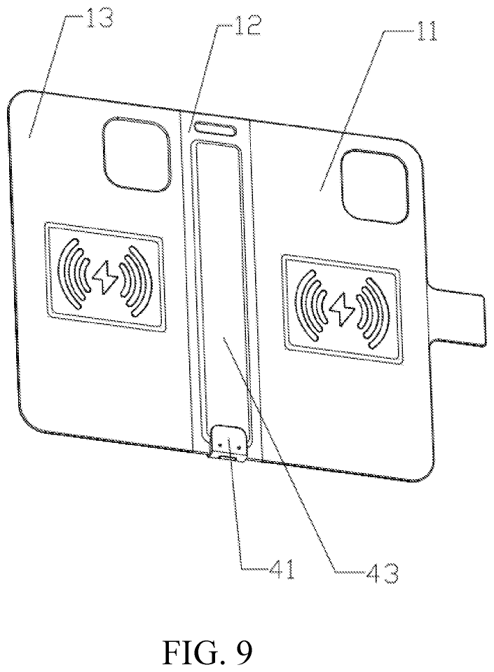

As shown in FIG. 9, the charging circuit board 43 is a hard circuit board, the hard circuit board is disposed in the folding portion 12, the first charging coil 44 and the second charging coil 45 are respectively and electrically connected to two sides of the hard circuit board through wires, and the at least one charging interface 41 is disposed at a lower portion of the hard circuit board and is electrically connected to the hard circuit board.

Specifically, different from the flexible circuit board 43 in the first embodiment, the charging circuit board 42 in the second embodiment is the hard circuit board, which cannot be folded along with the flexible board 1, and the hard circuit board is disposed on the flexible portion 12 for preventing normal folding of the flexible board 1 from being affected by the hard circuit board. Specifically, the hard circuit board is electrically connected to the first charging coil 44 and the second charging coil 45 on both sides through wires, thereby improving stability of the charging circuit board 43 and being convenient for production and manufacturing.

Based on above, the present disclosure provides the dual phone case having wireless charging function, the wireless charging assembly is disposed on the flexible board, where the flexible board is capable of mounting two mobile phones, to achieve that the two mobile phones are wirelessly charged at the same time, which has higher practicability. Further, the two mobile phones are stacked through the flexible board which is foldable, so that the two mobile phones are wirelessly charged at the same time while being prevented from being collided, which is convenient for the users to store and carry the two mobile phones without affecting work and use efficiency, thereby improving a degree of satisfaction of the users.

### Third Embodiment

Different from the first embodiment and the second embodiment, the third embodiment provides a dual phone case having wireless charging function, which connects two cases to a flexible board embedded with a wireless charging assembly for wirelessly charging two mobile phones at the same time. What's more, the two mobile phones and the two cases may respectively rotate along a first folding portion and a second folding portion along with a first mounting portion and a second mounting portion and abut against at both sides of a connecting portion.

In order to make those skilled in the art better understand the solutions of the embodiments of the present disclosure, the technical solutions in the embodiments of the present disclosure will be clearly and completely described below with reference to the accompanying drawings.

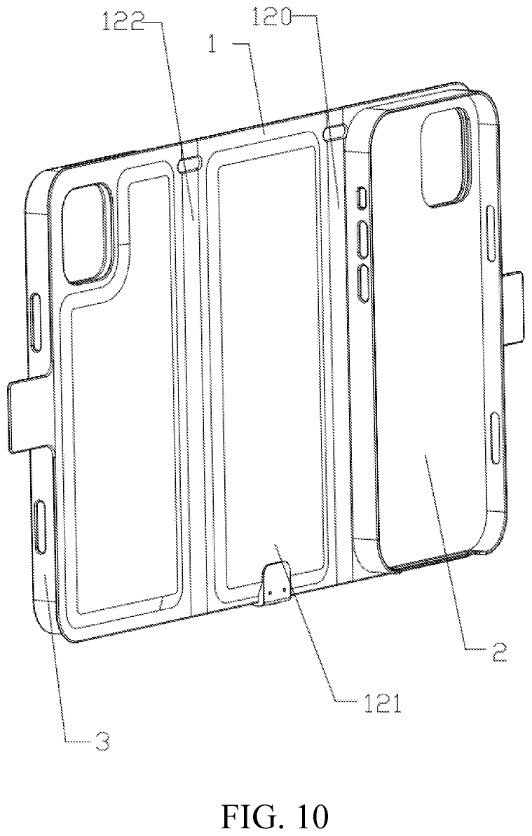

As shown in FIGS. 10-18, the present disclosure provides a dual phone case having wireless charging function, including a flexible board 1, a wireless charging assembly 4, a first case 2, and a second case 3. The flexible board 1 includes a first mounting portion 11, a first folding portion 120, a connecting portion 121, a second folding portion 122, and a second mounting portion 13, where the first mounting portion 11, the first folding portion 120, the connecting portion 121, the second folding portion 122, and the second mounting portion 13 are rotatably connected in sequence. The first case 2 is disposed on the first mounting portion 11, and the first case is capable of rotating along with the first mounting portion 11 and the first folding portion 120 to abut again a first side of the connecting portion 121. The second case 3 is disposed on the second mounting portion 13, and the second case 3 is capable of rotating along with the second mounting portion 13 and the second folding portion 122 to abut against a second side of the connecting portion 121. The wireless charging assembly 4 is disposed on the flexible board 1 and is configured to wirelessly charge the mobile phone.

Specifically, the first mounting portion 11, the first folding portion 120, the second folding portion 122, and the second mounting portion 13 are arranged in a length direction of the flexible board. When the flexible board 1 is in an unfolded state, the first case 2 and the second case 3 are respectively and detachably connected to the first mounting portion 11 and the second mounting portion 13, which is convenient for stacking the flexible board 1 and storing the mobile phone. When the flexible board 1 is in a folded state, the first mounting portion 11 and the second mounting portion 13 are respectively perpendicular to the first folding portion 120 and the second folding portion 122, and widths of the first folding portion 120 and the second folding portion 122 respectively match thicknesses of the first case 2 and the second case 3. The flexible board 1 is folded into a shape similar to an S shape, and the first case 2 and the second case 3 are disposed at openings on both sides of the S shape, which is convenient for wrapping the first case 2 and the second case 3 after the flexible board 1 is folded. The connecting portion 121 separates two mobile phones mounted in the first case 2 and the second case 3, which prevents the two mobile phones from being collided during a folding process or a carrying process, so that the mobile phones may have better protection.

When the wireless charging assembly 4 is powered on, the mobile phone mounted on the first case 2 or the second case 3 may be charged through the wireless charging assembly 4 disposed on the flexible board 1, so that the mobile phones are protected and meanwhile a function of wirelessly charging two mobile phones at the same time is further achieved, and practicability of the dual phone case having wireless charging function is further improved.

It should be noted that, in the embodiment, the mobile phones are provided with a wireless charging function.

In addition, when the two mobile phones are conveniently carried, the two mobile phones may be further associated, so that intelligent mobile phone tasks, such as making a call, receiving a call, shooting photos, and web browsing, may be carried out at the same time; or an independent task may be respectively carried out on the two mobile phones, therefor improving user experience. Certainly, the users may also only carry or use any one of the two mobile phones.

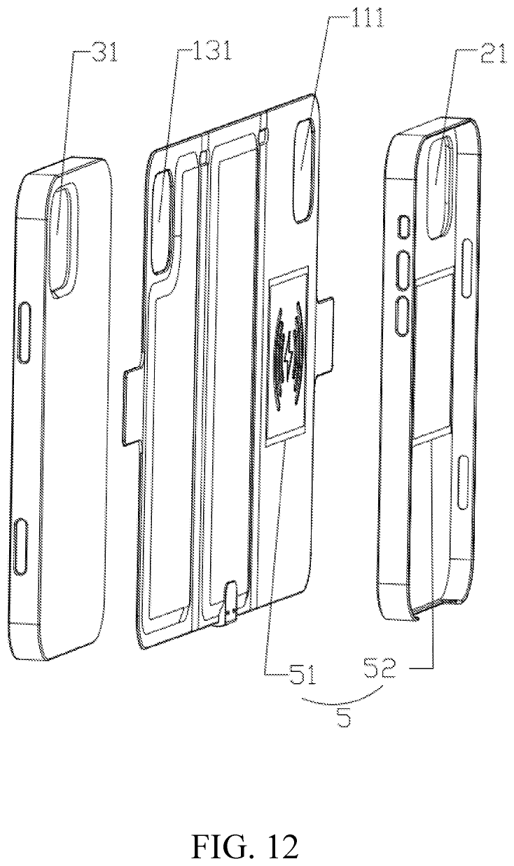

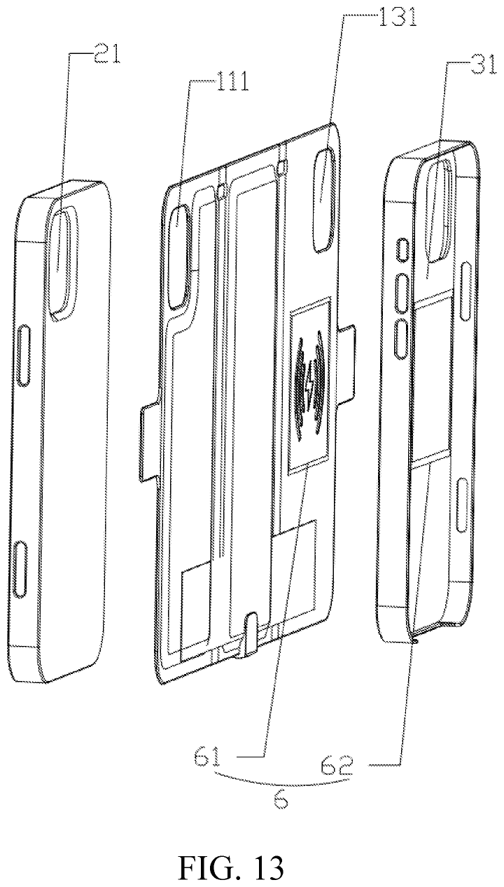

In one embodiment, as shown in FIGS. 12-13, the first case 2 is detachably disposed on the first mounting portion 11 through a first connecting assembly 5. The second case 3 is detachably disposed on the second mounting portion 13 through a second connecting assembly 6. Such form of detachable connection is convenient for the users to disassemble and assemble and use the dual phone case having wireless charging function according to actual requirements for use. For example, when there is no charging requirement and there is only one mobile phone to be used, the first case 2 and the first mounting portion 11 may be separated, so as to hold and further manipulate the one mobile phone; and when there is a charging requirement, the first case 2 is mounted back to the first mounting portion 11, which is flexible and convenient and further improves the user experience.

Specifically, connection between the first case 2, the second case 3 and the first mounting portion 11, the second mounting portion 13 is required to meet a condition of convenient disassembly. The first connecting assembly 5 and the second connecting assembly 6 may be configured to be in various assembly forms. For example, the first connecting assembly 5 may be configured to be in a form of a clamping assembly, that is, a clamping component and a clamping buckle are respectively disposed on the first mounting portion 11 and the first case 2, and the first case 2 is fixed through a cooperative relationship between the clamping component and the clamping buckle; or the first connecting assembly 5 may be a hook-and-loop fastener assembly, that is, a hook-and-loop fastener is disposed on the first mounting portion 11 and the first case 2, thereby fixing the first case 2. Similarly, the second connecting assembly 6 disposed between the second case 3 and the second mounting portion 13 may be also configured to be in various assembly forms. When there is a charging requirement, the mobile phone is mounted on the first case 2 and is connected to the first mounting portion 11, and then the mobile phone is capable of being charged, when charging is completed, there is only one mobile phone required to be used, only the first case 2 and the first mounting portion 11 are required to separate.

In one embodiment, as shown in FIGS. 12-13, the first connecting assembly 5 includes a first magnetic component 51 and a second magnetic component 52, the first magnetic component 51 is fixedly disposed on the first mounting portion 11, and the second magnetic component 52 is fixedly disposed on the first case 2, one of the first magnetic component 51 and the second magnetic component 52 is a first magnet, another one of the first magnetic component 51 and the second magnetic component 52 is a second magnet or a first magnetic metal. The second connecting assembly 6 includes a third magnetic component 61 and a fourth magnetic component 62, the third magnetic component 61 is fixedly disposed on the second mounting portion 13, and the fourth magnetic component 62 is fixedly disposed on the second case 3, one of the third magnetic component 61 and the fourth magnetic component 62 is a third magnet, another one of the third magnetic component 61 and the fourth magnetic component 62 is a fourth magnet or a second magnetic metal.

Specifically, the first magnetic component 51 and the second magnetic component 51 of the first connecting assembly 5 may be interchangeably disposed between the first case 2 and the first mounting portion 11, that is, a magnet may be disposed on the first case 2 and a magnetic metal is disposed in the first mounting portion 11, and a magnetic function may also be achieved on the contrary. Similarly, the third magnetic component 61 and the fourth magnetic component 62 of the second connecting assembly 6 disposed between the second case 3 and the second mounting portion 13 are interchangeably disposed between the second case 3 and the second mounting portion 13. The first connecting assembly 5 and the second connecting assembly 6 are configured to be in a form of magnetic structure, which is not only convenient for disassembling and assembling, but also simple in structure and convenient for manufacturing and using.

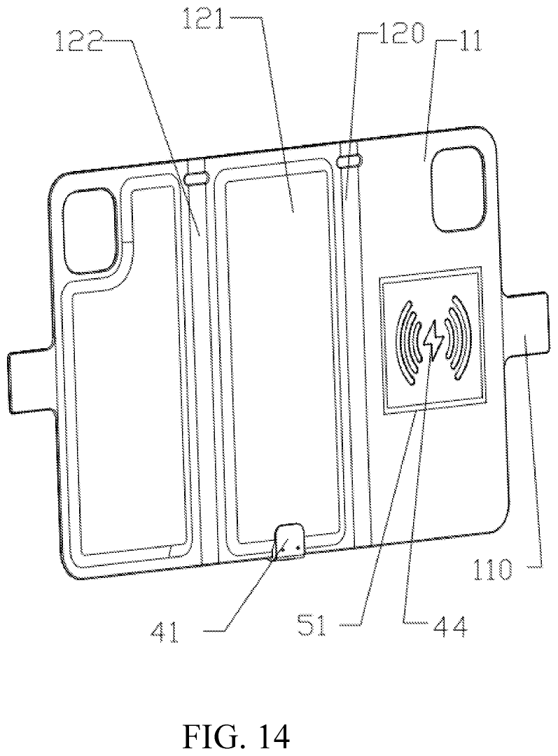

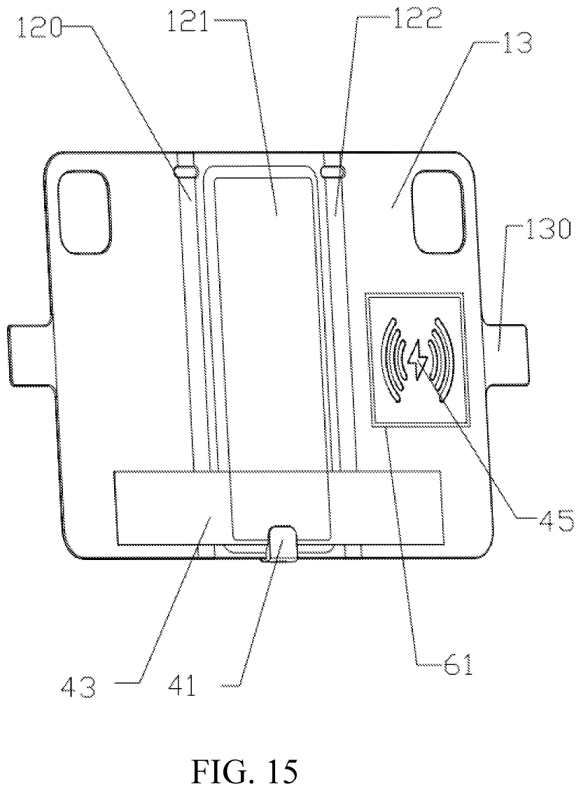

In one embodiment, as shown in FIGS. 14-15, the wireless charging assembly 4 includes a first charging coil 44, a second charging coil 45, and a charging circuit board, where at least one charging interface 41 is disposed on the charging circuit board. The first charging coil 44 and the second charging coil 45 are respectively disposed on the first mounting portion 11 and the second mounting portion 13. The charging circuit board is respectively and electrically connected to the first charging coil 44 and the second charging coil 45.

Specifically, the wireless charging assembly 4 is embedded in the flexible board 1 to reduce a volume of the dual phone case having wireless charging function for conveniently carrying the dual phone case. The first charging coil 44 and the second charging coil 45 are generally disposed at central positions of the first mounting portion 11 and the second mounting portion 13 and correspond to charging positions of the mobile phones provided with wireless charging function to achieve higher charging efficiency. Certainly, the first charging coil 44 and the second charging coil 45 may further disposed at other positions of the first mounting portion 11 and the second mounting portion 13, and corresponding charging efficiency may also be achieved through increasing coverage areas of the first charging coil 44 and the second charging coil 45. In addition, the first charging coil 44 and the second charging coil 45 obtain distributed current through electrically connecting with the charging circuit board, thereby achieving higher charging efficiency.

In one embodiment, a charging circuit connecting the at least one charging interface 41 with the first charging coil 44 and the second charging coil 45 is disposed on the charging circuit board. Specifically, the charging circuit belongs to a prior art, and details of which are not described herein.

In one embodiment, as shown in FIG. 15, the charging circuit board is a flexible circuit board 43, the flexible circuit board 43 is disposed on a lower portion of the flexible board 1 and further crosses the first mounting portion 11, the first folding portion 120, the connecting portion 121, the second folding portion 122, and the second mounting portion 13. The at least one charging interface 41 is disposed on a lower portion of the folding portion 12 and is further connected to the flexible circuit board 43.

Specifically, the flexible circuit board 43 is disposed on one side along the length direction of the flexible board 1 and is folded along with the first folding portion 120 and the second folding portion 122. The flexible circuit board 43 is electrically connected to the at least one charging interface 41, the first charging coil 44 and the second charging coil 45. When current enters from the at least one charging interface 41, the entered current is distributed in the flexible circuit board 43, and the entered current is distributed according to working states of the first charging coil 44 and the second charging coil 45. For example, when two mobile phones are connected to the flexible board 1 at the same time, the entered current are distributed to the first charging coil 44 and the second charging coil 45 at the same time and the two mobile phones begin to be charged. When there is only one mobile phone, the flexible circuit board 43 only distributes the entered current to one end connected with the one mobile phone, the structure of which improves charging efficiency of the phone case having wireless charging function on a basis of satisfying a charging function.

Specifically, the at least one charging interface 41 may be configured to be in different forms as required, that is, when only one charging interface 41 is provided, the charging interface 41 is disposed on an edge of the connecting portion 121 and enters the current into the flexible circuit board 43.

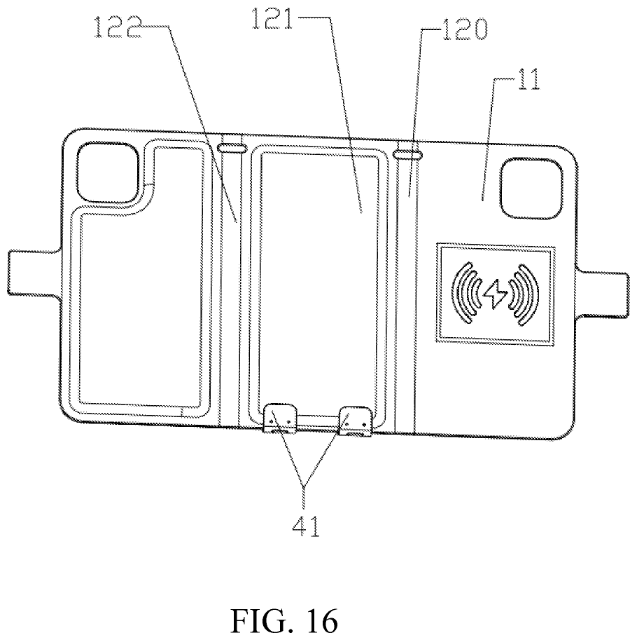

In one embodiment, as shown in FIG. 16, when there are two charging interfaces 41 disposed, the two charging interfaces 41 are respectively disposed on the edge of the connecting portion 121 at the same time, and the two charging interfaces 41 are respectively and electrically connected to the flexible circuit board 43. The two charging interfaces 41 may be configured to be of the same type or different types. For example, one of the two charging interfaces 41 is configured to be a Micro USB interface, and another one of the two charging interfaces 41 is a Micro USB interface or a USB type C interface. Such configuration may satisfy various charging situations, expand a range of application of the dual phone case having wireless charging function, and improve practicability of the dual phone case having wireless charging function.

It should be noted that a number of the charging interface 41 in the present disclosure is configured to be at least one, a type of the charging interface 41 may be configured to be the Micro USB interface, USB type C interface, or other charging interfaces capable of providing charging function. The number and the type of the charging interface 41 are not further limited in the present disclosure.

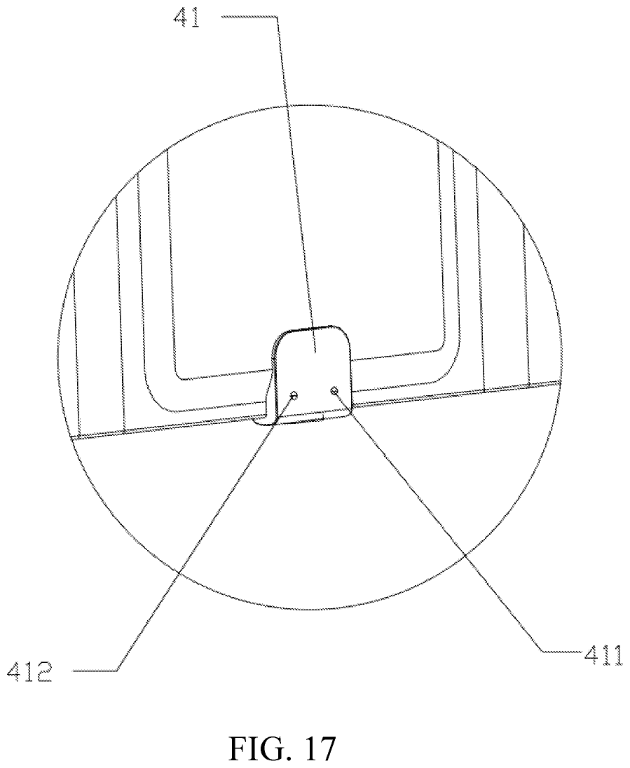

In one embodiment, as shown in FIG. 17, a first indicating lamp 411 and a second indicating lamp 412 are disposed on the at least charging interface, the first indicating lamp 411 and the second indicating lamp 412 are respectively and electrically connected to the first charging coil 44 and the second charging coil 45 through the flexible circuit board 43.

Specifically, the first indicating lamp 411 and the second indicating lamp 412 emit different light colors according to working states of the wireless charging assembly 4. When the wireless charging assembly 4 is connected to an external power supply, the first indicating lamp 411 and the second indicating lamp 412 emit green lights. When the first charging coil 44 and the second charging coil 45 begin to work, the first indicating lamp 411 and the second indicating lamp 412 emit red lights, when the mobile phone is fully charged, a charging detection circuit disposed in the flexible circuit board 43 detects that charging current is continuously lower than a certain value, a connection between the wireless charging assembly 4 and the mobile phone may be automatically cut off, and at this time, the first indicating lamp 411 and the second indicating lamp 412 emit green lights again for indicating that the mobile phone is fully charged. Such assembly may remind the users of stopping charging through light-emitting colors, thereby avoiding danger caused by overcharge of the mobile phone and further improving security.

It should be noted that the light-emitting colors of the first indicating lamp 411 and the second indicating lamp 412 in the present disclosure are in a principle of being convenient for identification, and the light-emitting colors are not limited in the present disclosure.

It should be also noted that both the charging detection circuit and indicating lamp circuit disposed in the flexible circuit board 43 are prior art, and details of which are not described herein again.

In one embodiment, the dual phone case having wireless charging function further includes a battery module 42 which is not shown in the drawings, the battery module 42 is disposed on the connecting portion 121, the battery module 42 is electrically connected to the flexible circuit board 43.

Specifically, the battery module 42 is disposed on the connecting portion 121 as a backup power source, so that power is provided for the wireless charging assembly 4 without the external power supply, when the external power supply is connected, the battery module 42 is charged while charging the mobile phone, thereby solving a problem of being difficult to charge outdoors and further improving the dual phone case having wireless charging function.

In one embodiment, the flexible board 1 is formed through connecting a plurality of leather pieces, mounting inner cavities are respectively defined on inner sides of the plurality of the leather pieces, and the mounting inner cavities are communicated and are configured to mount the wireless charging assembly 4. Selecting leather as a material for making the flexible board 1 improves a comfort level of the dual phone case having wireless charging function, and further improves the protection role played in the mobile phones and the wireless charging assembly 4 mounted therein. Moreover, the leather is soft in texture and convenient to fold and use.

It should be noted that the flexible board 1 may also be made of plastic or other materials that are soft and convenient to fold and capable of being made into the inner cavities, and the material of the flexible board 1 is not further limited in the embodiments of the present disclosure.

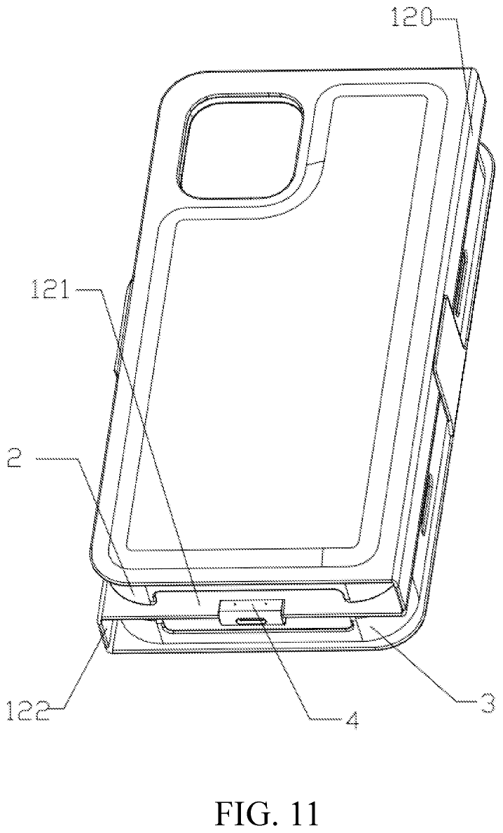

In one embodiment, as shown in FIGS. 11-15, a first connecting strip 110 is disposed on the first mounting portion 11. A fifth magnetic component is disposed on the first connecting strip 110, and a sixth magnetic component is disposed on the second folding portion 122, which are not shown in the drawing. One of the fifth magnetic component and the sixth magnetic component is a fifth magnet, and another one of the fifth magnetic component and the sixth magnetic component is a sixth magnet or a third magnetic metal. The first connecting strip 110 is detachably connected to the second folding portion 122 through the fifth magnetic component and the sixth magnetic component when the flexible board 1 is in a folded state.

A second connecting strip 130 is disposed on the second mounting portion 13. A seventh magnetic component is disposed on the second connecting strip 130, and an eighth magnetic component is disposed on the first folding portion 120, which are not shown in the drawings. One of the seventh magnetic component and the eighth magnetic component is a seventh magnet, and another one of the seventh magnetic component and the eighth magnetic component is an eighth magnet or a fourth magnetic metal. The second connecting strip 130 is detachably connected to the first folding portion 120 through the seventh magnetic component and the eighth magnetic component when the flexible board 1 is in the folded state.

The first connecting strip 110 and the second connecting strip 130 configured to be in same forms as the first connecting assembly 5 and the second connecting assembly 6 play a role in fixing the flexible board 1 in a folding state, and the flexible plate 1 may keep a stable folding state through cooperation of the fifth magnetic component, the sixth magnetic component, the seventh magnetic component and the eighth magnetic component.

Specifically, after the flexible board 1 and the first case 2 and the second case 3 are folded along the folding portion 12, the flexible board is easily unfolded during a carrying process, so that the mobile phones mounted in the first case 1 and the second case 3 fall off or are damaged. The first connecting strip 110 and the second connecting strip 130 fix the folded flexible board 1 through magnet effect, which is convenient for disassembling, so that the flexible board 1 is kept in the folded state and the first mounting portion 11 and the second mounting portion 13 are kept in a stacked state. Thereby, a situation that the mobile phones are damaged due to a fact that the dual phone case having wireless charging function is easily unfolded during a charging and carrying process is prevented, and the practicability of the dual phone case having wireless charging function is further improved.

Furthermore, as shown in FIGS. 12-13, a first camera hole 21 and a second camera hole 31 are respectively disposed on the first case 2 and the second case 3, and the first camera hole 21 and the second camera hole 31 coincide with a third camera hole 111 defined on the first mounting portion 11 and a fourth camera hole 131 defined on the second mounting portion 13.

Specifically, the first camera hole 21 and the third camera hole 111 correspond to positions of cameras of the mobile phone mounted on the first case 2. For example, in the embodiment, the cameras of the mobile phone are disposed on a vertex angle of the mobile phone, correspondingly, the first camera hole 21 is defined at a vertex angle of the first case 2, and the third camera hole 111 is defined at a vertex angle of the first mounting portion 11, so that normal use, such as shooting photos, of the mobile phone may not be affected in the charging or carrying process. The second case 3 and the second mounting portion 13 have similar configuration principle, and the practicability is higher.

Furthermore, areas of the first mounting portion 11 and the second mounting portion 13 are respectively greater than areas of the first case 2 and the second case 3. The first case 2 and the second case 3 are respectively and centrally disposed on the first mounting portion 11 and the second mounting portion 13, and partial portions of the first mounting portion 11 and the second mounting portion 13 are left at peripheries of the first case 2 and the second case 3, so that the mobile phones and a wireless charging device mounted in the dual phone case having wireless charging function may be better protected.

Furthermore, rope hanging holes for connecting hanging ropes are defined on both the first folding portion 120 and the second folding portion 122, the rope hanging holes are defined on upper portions of the first folding portion 120 and the second folding portion 122 for facilitating connecting the hanging ropes, and the dual phone case having wireless charging function may be hung on a neck or other portable portions through the hanging rope, which is simple in structure and convenient in use.

### Fourth Embodiment

A structure of the dual phone case having wireless charging function in the fourth embodiment is approximately the same as that of the third embodiment, and differences are as following.

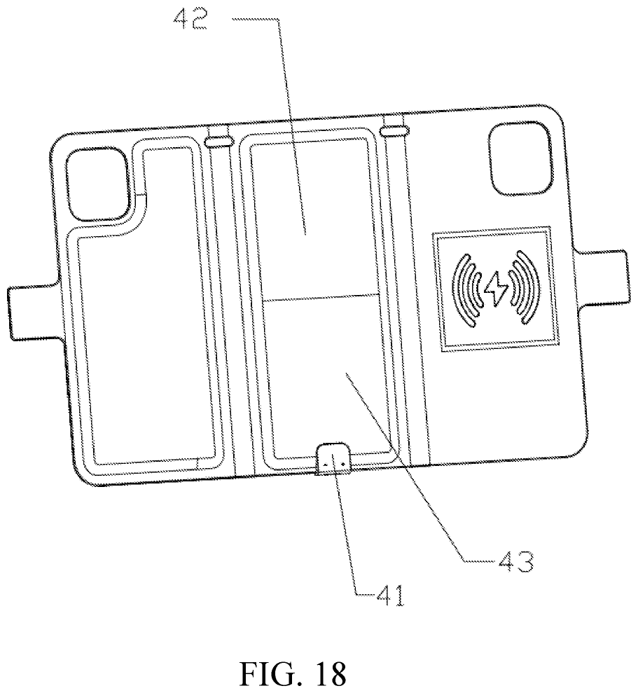

As shown in FIG. 18, the charging circuit board 43 is a hard circuit board, the hard circuit board is disposed in the connecting portion 13, the first charging coil 44 and the second charging coil 45 are respectively and electrically connected to two sides of the hard circuit board through wires, and the at least one charging interface 41 is disposed at a lower portion of the connecting portion 121 and is electrically connected to the hard circuit board.

Specifically, different from the flexible circuit board 43 in the third embodiment, the charging circuit board 43 in the fourth embodiment is the hard circuit board, which cannot be folded along with the flexible board 1, and the hard circuit board is disposed on the flexible portion 12 for preventing normal folding of the flexible board 1 from being affected by the hard circuit board. Specifically, the hard circuit board is electrically connected to the first charging coil 44 and the second charging coil 45 on both sides through wires, thereby improving stability of the charging circuit board 43 and being convenient for production and manufacturing.

Based on above, the present disclosure provides the dual phone case having wireless charging function, the wireless charging assembly is disposed on the flexible board, where the flexible board is capable of mounting two mobile phones, to achieve that the two mobile phones are wirelessly charged at the same time, which has higher practicability. Further, the two mobile phones are stacked through the flexible board which is foldable, so that the two mobile phones are wirelessly charged at the same time while being prevented from being collided, which is convenient for the users to store and carry the two mobile phones without affecting work and use efficiency, thereby improving a degree of satisfaction of the users.

The foregoing is merely a preferred embodiment of the present disclosure, and is not used to limit the present disclosure. For those skilled in the art, the present disclosure may have various changes and changes. Any modification, equivalent replacement, improvement, etc. made within the spirit and principle of the present disclosure shall fall within the scope of the claims of the present disclosure.

What is claimed is:

1. A dual phone case having wireless charging function, comprising:
a flexible board;
a first case;
a second case; and
a wireless charging assembly;
wherein the flexible board comprises a first mounting portion and a second mounting portion, where the first mounting portion is folded with the second mounting portion; the first case is configured to fix a mobile phone, and the first case is disposed on the first mounting portion; the second case is configured to fix the mobile phone, and the second case is disposed on the second mounting portion; the wireless charging assembly is configured to wirelessly charge the mobile phone, and the wireless charging assembly is disposed on the flexible board.

2. The dual phone case having wireless charging function according to claim 1, wherein the flexible board further comprises a folding portion, the folding portion is disposed between the first mounting portion and the second mounting portion; the first mounting portion and the second mounting portion are folded along the folding portion, the first case is rotated and folded along with the first mounting portion along the folding portion and abuts against the second case.

3. The dual phone case having wireless charging function according to claim 1, wherein the flexible board further comprises a first folding portion, a connecting portion, and a second folding portion; the first mounting portion, the first folding portion, the connecting portion, the second folding portion, and the second mounting portion are connected in sequence; the first case is capable of rotating along with the first mounting portion and the first folding portion to abut against a first side of the connecting portion, and the second case is capable of rotating along with the second mounting portion and the second folding portion to abut against a second side of the connecting portion.

4. The dual phone case having wireless charging function according to claim 1, wherein the first case is detachably disposed on the first mounting portion through a first connecting assembly; and/or the second case is detachably disposed on the second mounting portion through a second connecting assembly.

5. The dual phone case having wireless charging function according to claim 4, wherein the first connecting assembly comprises a first magnetic component and a second magnetic component, the first magnetic component is fixedly disposed on the first mounting portion, and the second magnetic component is fixedly disposed on the first case; one of the first magnetic component and the second magnetic component is a first magnet, another one of the first magnetic component and the second magnetic component is a second magnet or a first magnetic metal; and/or
the second connecting assembly comprises a third magnetic component and a fourth magnetic component, the third magnetic component is fixedly disposed on the second mounting portion, and the fourth magnetic component is fixedly disposed on the second case; one of the third magnetic component and the fourth magnetic component is a third magnet, another one of the third magnetic component and the fourth magnetic component is a fourth magnet or a second magnetic metal.

6. The dual phone case having wireless charging function according to claim 2, wherein the wireless charging assembly comprises a first charging coil, a second charging coil, and a charging circuit board, where at least one charging interface is disposed on the charging circuit board; the first charging coil and the second charging coil are respectively disposed on the first mounting portion and the second mounting portion; the charging circuit board is respectively and electrically connected to the first charging coil and the second charging coil.

7. The dual phone case having wireless charging function according to claim 6, wherein the charging circuit board is a flexible circuit board, the flexible circuit board is disposed on a lower portion of the flexible board and further crosses the first mounting portion, the folding portion, and the second mounting portion; the at least one charging interface is disposed on a lower portion of the folding portion and is further connected to the flexible circuit board.

8. The dual phone case having wireless charging function according to claim 6, wherein the charging circuit board is a hard circuit board, the hard circuit board is disposed in the folding portion and is electrically connected to the first charging coil and the second charging coil through leading wires; the at least one charging interface is disposed on a lower portion of the hard circuit board and is further electrically connected to the hard circuit board.

9. The dual phone case having wireless charging function according to claim 6, where a first indicating lamp and a second indicating lamp are disposed on the at least one charging interface; the first indicating lamp and the second indicating lamp are respectively and electrically connected to the first charging coil and the second charging coil through the charging circuit board.

10. The dual phone case having wireless charging function according to claim 6, wherein the dual phone case having wireless charging function further comprises a battery module; the battery module is disposed on the folding portion, and the battery module is electrically connected to the charging circuit board.

11. The dual phone case having wireless charging function according to claim 3, wherein the wireless charging assembly comprises a first charging coil, a second charging coil, and a charging circuit board, where at least one charging interface is disposed on the charging circuit board; the first charging coil and the second charging coil are respectively disposed on the first mounting portion and the second mounting portion, and the charging circuit board is respectively and electrically connected to the first charging coil and the second charging coil.

12. The dual phone case having wireless charging function according to claim 11, wherein the charging circuit board is a flexible circuit board, the flexible circuit board is disposed on a lower portion of the flexible board and further crosses the first mounting portion, the first folding portion, the connecting portion, the second folding portion, and the second mounting portion; the at least one charging interface is disposed on a lower portion of the folding portion and is further connected to the flexible circuit board.

13. The dual phone case having wireless charging function according to claim 11, wherein the charging circuit board is a hard circuit board, the hard circuit board is disposed in the folding portion and is electrically connected to the first charging coil and the second charging coil through leading wires; the at least one charging interface is disposed on a lower portion of the hard circuit board and is further electrically connected to the hard circuit board.

14. The dual phone case having wireless charging function according to claim 11, wherein the dual phone case having wireless charging function further comprises a battery module; the battery module is disposed on the connecting portion, and the battery module is electrically connected to the charging circuit board.

15. The dual phone case having wireless charging function according to claim 2, wherein a connecting strip is disposed on an edge of the first mounting portion; a fifth magnetic component is disposed on the connecting strip, a sixth magnetic component is disposed on the second mounting portion; and the connecting strip is detachably connected to the second mounting portion through the fifth magnetic component and the sixth magnetic component when the flexible board is in a folded state; and
one of the fifth magnetic component and the sixth magnetic component is a fifth magnet, and another one of the fifth magnetic component and the sixth magnetic component is a sixth magnet or a third magnetic metal.

16. The dual phone case having wireless charging function according to claim 2, wherein a first connecting strip is disposed on the first mounting portion, and a fifth magnetic component is disposed on the first connecting strip; a second connecting strip is disposed on the second mounting portion, and a sixth magnetic component is disposed on the second connecting strip; the first connecting strip and the second connecting strip are connected through the fifth magnetic component and the sixth magnetic component when the flexible board is in a folded state; and
one of the fifth magnetic component and the sixth magnetic component is a fifth magnet, and another one of the fifth magnetic component and the sixth magnetic component is a sixth magnet or a third magnetic metal.

17. The dual phone case having wireless charging function according to claim 3, wherein a first connecting strip is disposed on the first mounting portion, a fifth magnetic component is disposed on the first connecting strip, and a sixth magnetic component is disposed on the second folding portion; one of the fifth magnetic component and the sixth magnetic component is a fifth magnet, and another one of the fifth magnetic component and the sixth magnetic component is a sixth magnet or a third magnetic metal; the first connecting strip is detachably connected to the second folding portion through the fifth magnetic component and the sixth magnetic component when the flexible board is in a folded state; and/or
a second connecting strip is disposed on the second mounting portion, a seventh magnetic component is disposed on the second connecting strip, and an eighth magnetic component is disposed on the first folding portion; one of the seventh magnetic component and the eighth magnetic component is a seventh magnet, and another one of the seventh magnetic component and the eighth magnetic component is an eighth magnet or a fourth magnetic metal; the second connecting strip is detachably connected to the first folding portion through the seventh magnetic component and the eighth magnetic component when the flexible board is in the folded state.

18. The dual phone case having wireless charging function according to claim 1, wherein the flexible board is formed through connecting a plurality of leather pieces, mounting inner cavities are respectively defined on inner sides of the plurality of the leather pieces, and the mounting inner cavities are communicated and are configured to mount the wireless charging assembly.
